(19) United States
(12) Patent Application Publication
(10) Pub. No.: US 2018/0079062 A1
(43) Pub. Date: Mar. 22, 2018

(54) STRIKING TOOLS

(71) Applicant: Estwing Manufacturing Company, Inc., Rockford, IL (US)

(72) Inventor: Joshua D. West, Rockford, IL (US)

(21) Appl. No.: 15/272,279

(22) Filed: Sep. 21, 2016

(51) Int. Cl. B25D 1/02; B25D 1/04; B25G 3/26

(52) U.S. Cl. CPC B25D 1/02; B25G 3/26; B25D 1/04

(57) ABSTRACT

A striking tool disclosed herein includes a body having a first lateral side and a second lateral side opposite the first lateral side. The striking tool further includes a handle including a shank. The body is integral with the shank. The striking tool also includes an implement including a bracket. The bracket abuts a butt end of the body and the handle and overlaps a portion of the first lateral side of the body. The striking tool further includes a fastener extending from the first lateral side toward the second lateral side and through the bracket.

### FIELD

This disclosure relates generally to hand tools, and more specifically, to striking tools.

### BACKGROUND

Striking tools such as nail hammers often include a head having a striking surface. Typically, the entire head is formed from steel.

### BRIEF DESCRIPTION OF THE DRAWINGS

FIG. 1 is an isometric view of a striking tool in accordance with the teachings of this disclosure.

FIG. 2 is an exploded top, first side isometric view of a portion of the striking tool of FIG. 1.

FIG. 3 is an exploded top, second side isometric view of a portion of the striking tool of FIGS. 1-2.

FIG. 4 is a cross-sectional view of a portion of the striking tool of FIGS. 1-3 taken generally along line 4-4 of FIG. 1.

FIG. 5 is a top isometric view of an implement of the striking tool of FIGS. 1-4.

FIG. 6 is a front view of the implement of FIG. 5.

FIG. 7 is a side view of the striking tool of FIGS. 1-5.

Wherever possible, the same reference numbers will be used throughout the drawings and accompanying written description to refer to the same or like components or features. As used in this patent, stating that any component or feature is in any way positioned on (e.g., positioned on, located on, disposed on, or formed on, etc.) another component or feature, means that the referenced component or feature is either in contact with the other component or feature, or that the referenced component or feature is on the other component or feature with one or more intermediate component(s) or feature(s) located therebetween. Stating that any component or feature is in contact with another component or feature means that there is no intermediate component or feature between the two component or feature.

### DETAILED DESCRIPTION

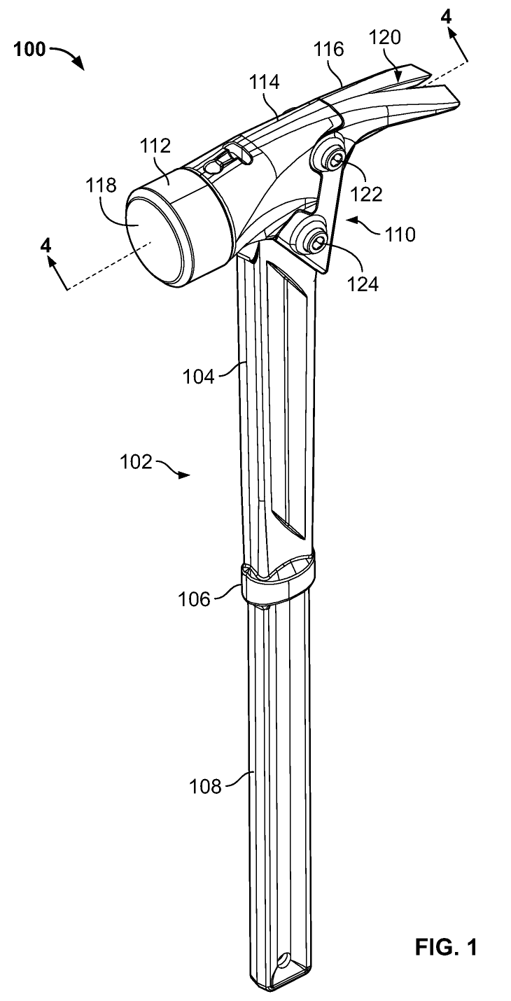

FIG. 1 is a perspective view of a striking tool 100 in accordance with the teachings of this disclosure. The striking tool 100 of FIG. 1 is a framing hammer. Although the following description of the striking tool 100 of FIG. 1 involves a framing hammer, the teachings of this disclosure are applicable to other types of striking tools such as, for example, bricklayer hammers, ball peen hammers, drywall hammers, roofing hammers, pry bars, and other types of striking tools. The striking tool 100 of FIG. 1 includes a handle 102. The handle 102 includes a shank 104, a collar 106, and a stalk 108. The collar 106 is disposed between the shank 104 and the stalk 108. The stalk 108 receives a grip (not shown). The grip may be one or more materials such as, for example, leather, plastic, rubber, wood, foam, an elastomeric material, and a vibration reducing grip material, one or more materials disclosed in U.S. Pat. No. 6,465,535, and/or one or more additional and/or alternative materials. U.S. Pat. No. 6,465,535 is incorporated by reference herein in its entirety. In some embodiments, the grip has a Shore A durometer of about 40 to about 80, about 50 to about 75, about 63 to about 73. In some embodiments, the grip has a Shore A durometer of about 60, about 65, or about 68. In some embodiments, the grip is molded to the stalk 108 to couple the grip to the stalk 108. In other embodiments, the grip is coupled to the stalk 108 in one or more additional and/or alternative ways (e.g., via an adhesive, fasteners, etc.).

The striking tool 100 of FIG. 1 includes a head 110. The head 110 includes a cap 112, a body 114, and an implement 116. The shank 104 of the handle 102 extends from the collar 106 to the head 110. In the illustrated embodiment, the body 114 is integral with the handle 102. For example, the body 114 and the handle 102 of FIG. 1 are forged from a single piece of 6061 aluminum alloy. In some embodiments, the body 114 and the handle 102 are heat treated via, for example, a T6 solution heat treatment. In other embodiments, the body 114 and the handle 102 are distinct components, and the body 114 is coupled to the handle 102 (e.g., via a weld, a press fit, etc.).

In some embodiments, the body 114 and/or the handle 102 may be a material such as, for example, metal, polymer, plastic, composite, wood or other natural material, carbon fiber, graphite, fiberglass, foam, rubber, and/or one or more additional and/or alternative materials. For example, the body 114 and/or the handle 102 may be a metal such as, for example, titanium, aluminum, steel, and/or alloys of titanium, aluminum, and/or steel. In some embodiments, the body 114 and/or the handle 102 are one or more polymers, metal alloys, and/or superalloys suitable for additive manufacturing. In some embodiments, the body 114 is an aluminum alloy such as, for example, 2000, 4000, 6000, 7000, and/or 8000 series alloy(s). In some embodiments, the body 114 is an aluminum alloy such as, for example, 1050/1200, 2014A, 3103/3003, 5251/5052, 5454, 5083/5182, 6005A, 6061/6082, 6061, 6063, 7020, and/or 7075 aluminum alloy.

In the illustrated embodiment, the cap 112 includes a striking surface 118 to strike an object such as, for example, a nail, board, and/or other objects. In the illustrated embodiment, the striking surface 118 is convex. In other embodiments, the striking surface 118 is flat or planar. In the illustrated embodiment, the cap 112 is steel (e.g., 1055 steel). Thus, in the illustrated embodiment, the cap 112 has a hardness greater than the body 114. In other embodiments, the cap 112 may be one or more additional and/or alternative materials.

The implement 116 of FIG. 1 includes a claw 120. In other embodiments, the implement 116 may include one or more additional and/or alternative features and/or components such as, for example, a chisel, a peen, and/or one or more additional and/or alternative features and/or components. In the illustrated embodiment, the implement 116 is steel (e.g., 1055 steel). Thus, in the illustrated embodiment, the implement 116 has a hardness greater than the body 114. In other embodiments, the implement 116 may be one or more additional and/or alternative materials. In the illustrated embodiment, the implement 116 is coupled to the body 114 via a first fastener 122 (e.g., a bolt) and a second fastener 124 (e.g., a bolt). In other embodiments, the implement 116 is coupled to the body 114 via other numbers of fasteners (e.g., 1, 3, 4, 5, etc.) and/or in one or more additional and/or alternative ways (e.g., a weld, a press fit, etc.).

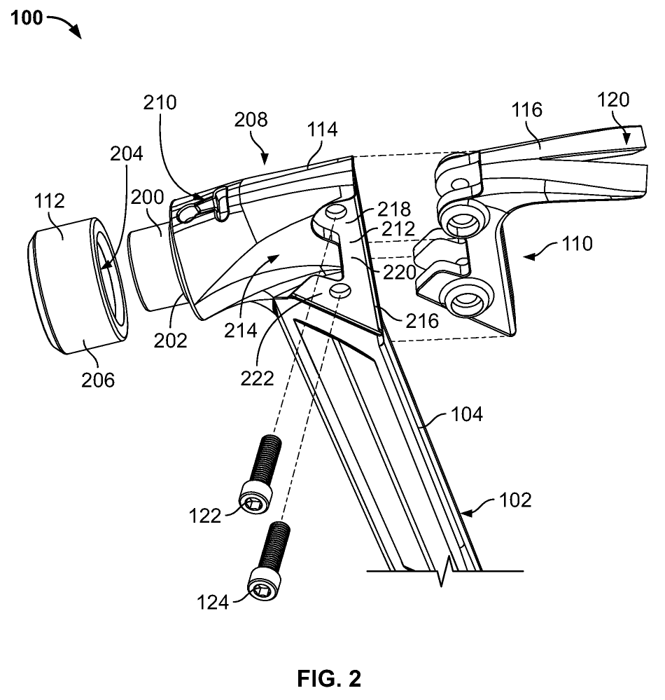

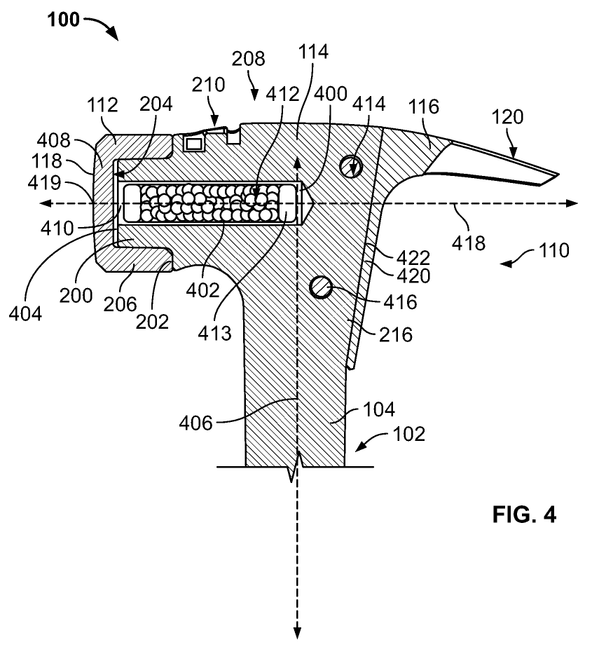

FIG. 2 is an exploded view of the striking tool 100 of FIG. 1. In the illustrated embodiment, the body 114 includes a neck or post 200 extending from a shoulder 202 of the body 114. The cap 112 is coupled to the post 200 via a press fit as, for example, described in U.S. application Ser. Nos. 14/587,452 and/or 14/587,503, which are incorporated by reference herein in their entirety. In the illustrated embodiment, the cap 112 of FIG. 2 includes a first cavity 204 defined by a sidewall 206 and an end wall 408 (FIG. 4). The post 200 is received in the first cavity 204 of the cap 112, and the post 200 interacts with the sidewall 206 of the cap 112 to press fit the cap 112 to the post 200. In some embodiments, the cap 112 is permanently coupled to the post 200 via only a press fit (e.g., no intervening parts or other components couple the cap 112 to the post 200). In some embodiments, a portion of the post 200 and/or a portion of the sidewall 206 is tapered to facilitate the cap 112 being press fit to the post 200.

In the illustrated embodiment, when the striking surface 118 strikes an object, the cap 112 may deform a portion of the post 200 because the cap 112 has a greater hardness than the post 200. As a result, an amount of friction between the cap 112 and the post 200 may increase, strengthening an interaction (i.e., the press fit) between the cap 112 and the post 200. For example, upon the striking surface 118 striking an object, force may be transferred from the cap 112 to the post 200 such that the post 200 expands toward the sidewall 206 of the cap 112 (e.g., a diameter or width of the post 200 increases). As a result, the amount of friction securing the cap 112 to the post 200 increases. Thus, striking the striking surface 118 of the striking tool 100 against objects facilitates retention of the cap 112 on the body 114.

A top side 208 of the body 114 includes a nail starter 210. The top side 208 of the body 114 is a first side of the body 114 opposite a second side or underside of the body 114 that includes a junction of the handle 102 and the body 114. The nail starter 210 supports a nail on the top side 208 of the body 114 to facilitate piercing of an object with the nail.

The striking tool 100 includes a first recess 212. The first recess 212 is disposed on a first lateral side 214 of the striking tool 100 and extends from the body 114 of the head 110 to the shank 104 of the handle 102. The first lateral side 214 of the striking tool 100 faces generally perpendicularly to the striking surface 118 of the cap 112. The first recess 212 also extends from a butt end 216 of the body 114 and the handle 102 toward the striking surface 118. In the illustrated embodiment, the first recess 212 includes a first section 218, a second section 220, and a third section 222. The second section 220 is disposed between the first section 218 and the third section 222. The first section 218 and the third section 222 are transverse to the second section 220. In the illustrated embodiment, the second section 220 and the third section 222 form an elbowed or V-shaped section. In other embodiments, the first recess 212 has other configurations. For example, in some embodiments, the first recess 212 has different numbers of sections (e.g., 2, 4, etc.), differently shaped sections, differently sized sections, and/or other configurations.

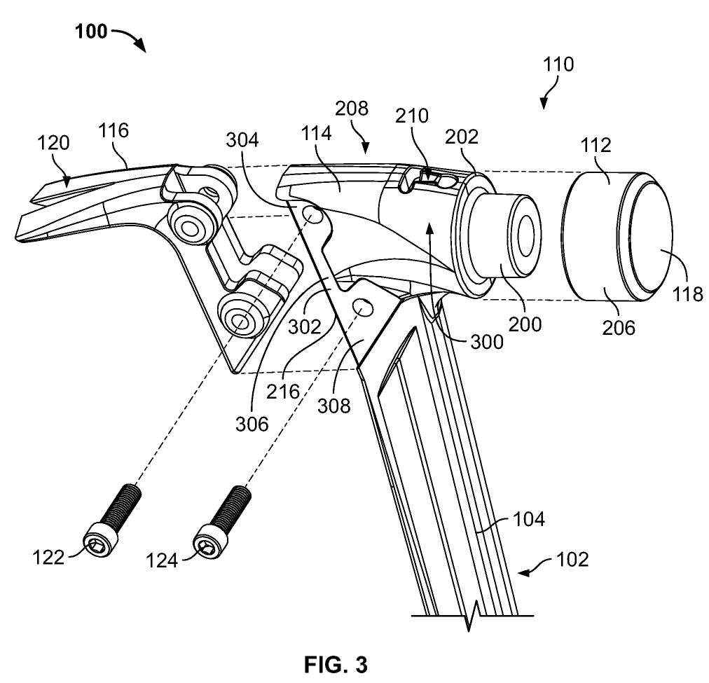

FIG. 3 is an exploded view of a second lateral side 300 of the striking tool 100 of FIGS. 1-2. The second lateral side 300 is opposite of the first lateral side 214. In the illustrated embodiment, the striking tool 100 includes a second recess 302. The second recess 302 is disposed on the second lateral side 300 and extends from the body 114 of the head 110 to the shank 104 of the handle 102. The second recess 302 also extends from the butt end 216 of the body 114 and the handle 102 toward the striking surface 118. In the illustrated embodiment, the second recess 302 includes a first section 304, a second section 306, and a third section 308. The second section 306 is disposed between the first section 304 and the third section 308. The first section 304 and the third section 308 are transverse to the second section 306. In the illustrated embodiment, the second section 306 and the third section 308 form an elbowed or V-shaped section. In the illustrated embodiment, the second recess 302 is a mirror image of the first recess 214. In other embodiments, the second recess 302 has other configurations. For example, in some embodiments, the second recess 302 has different numbers of sections, differently shaped sections, differently sized sections, and/or other configurations.

FIG. 4 is a cross-sectional view of the striking tool 100 of FIGS. 1-3 taken along line 4-4 of FIG. 1. In the illustrated embodiment, the head 110 includes a second cavity or receptacle 400. The second cavity 400 of FIG. 1 is defined by a bore 402 in the body 114 extending from an end face 404 of the post 200 towards the butt end 216 of the body 114. In the illustrated embodiment, the bore 402 extends substantially perpendicular to a central, longitudinal axis 406 of the handle 102. An end wall 408 of the cap 112 covers an opening 410 of the bore 402 and defines a portion of the second cavity 400. In the illustrated embodiment, the second cavity 400 has a depth such that the central, longitudinal axis 406 of the handle 102 passes through a portion of the second cavity 400.

In the illustrated embodiment, shot 412 is disposed in the second cavity 400. When the head 110 strikes an object, the shot 412 reduces vibration of the handle 102 of the striking tool 100 relative to an amount of vibration that would propagate through the handle 102 if the head 110 did not include the shot 412. In the illustrated embodiment, the shot 412 is spheres or balls. In other embodiments, the shot includes pellets, a slug, powder, and/or other types of shot. In some embodiments, the shot 412 is contained in a capsule 413, and the capsule 413 is disposed in the second cavity 400. In other embodiments, the shot 412 is not contained in the capsule 413 and, thus, is loose in the second cavity 400. In the illustrated embodiment, about 50 percent of the second cavity 400 by volume is filled with the shot 412 (i.e., the second cavity 400 is about half full with the shot 412). The shot 412 of FIG. 4 is steel and weighs about 0.5 ounces. In other embodiments, more or less of the second cavity 400 by volume is filled with the shot 412. For example, in some embodiments, about 30 percent to about 70 percent of a volume of the second cavity 400 is filled with the shot 412. The shot 412 may be other materials and/or weigh other amounts in other embodiments.

In the illustrated embodiment, the head 114 includes a first aperture 414 and a second aperture 416. The first fastener 122 (FIGS. 1-3) extends through the first aperture 414. The second fastener 124 (FIGS. 1-3) extends through the second aperture 416. In the illustrated embodiment, the first aperture 414 and the second aperture 416 (and, thus, the first fastener 122 and the second fastener 124) extend through the body 114 and from the first lateral side 214 (FIG. 2) to the second lateral side 300 (FIG. 3) of the body 114. For example, the first aperture 414 and the second aperture 416 may extend substantially perpendicular to (a) the longitudinal axis 406 of the handle 102 and (b) an axis 418 that is perpendicular to the longitudinal axis 406 and extends through a center 419 of the striking surface 118 the cap 112 and the butt end 216 of the body 114. In the illustrated embodiment, the first aperture 414 and the second aperture 416 are aft of the central, longitudinal axis 406 of the handle 102 (i.e., to the right of the central, longitudinal axis 406 from the perspective of FIG. 4). The first aperture 414 is disposed between the top side 208 of the head 110 and the axis 418. The second aperture 416 is disposed between the shank 104 and the axis 418. In some embodiments, the second aperture 416 extends through the shank 104. In the illustrated embodiment, a shortest first distance from the first aperture 414 to the axis 418 is less than a shortest second distance from the second aperture 416 to the axis 418.

In the illustrated embodiment, the implement 116 includes a bracket 420. The bracket 420 includes a spine 422. The spine 422 extends from the top side 208 of the body 114 to the shank 104 of the handle 102. In the illustrated embodiment, the spine 422 abuts the butt end 216 of the body 114 and the shank 104. In other embodiments, the spine 422 is configured in other ways.

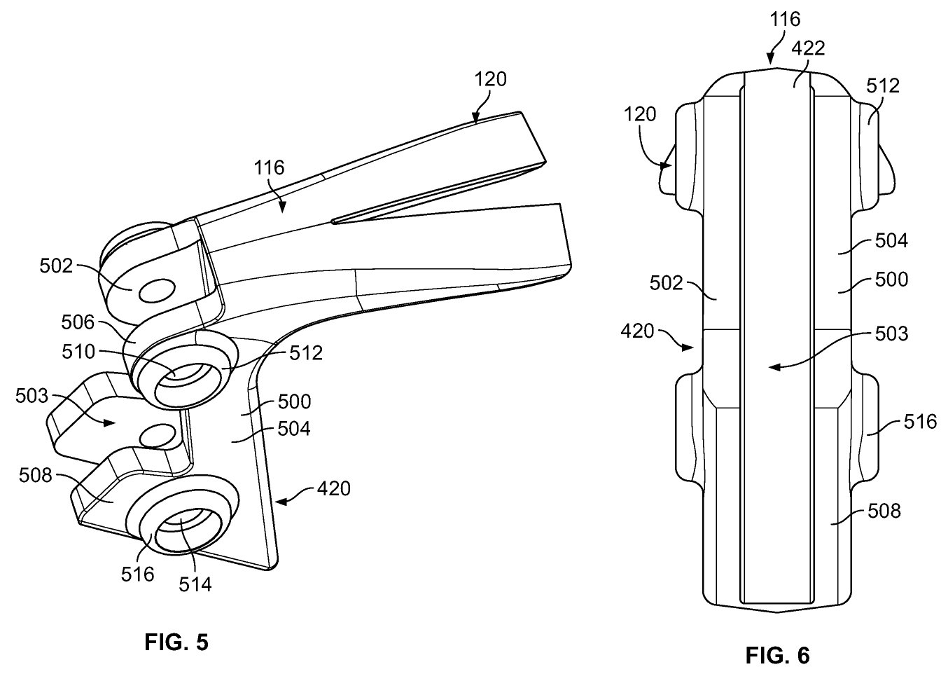

FIGS. 5-6 illustrate the implement 116 of FIGS. 1-4. FIG. 5 is a perspective view of the implement 116 of FIGS. 1-4. FIG. 6 is a front view of the implement 116 of FIGS. 1-5. With reference to FIGS. 5 and 6, the bracket 420 of the implement 116 includes a first brace 500 and a second brace 502 (FIG. 6). A channel 503 is disposed between the first brace 500 and the second brace 502. In the illustrated embodiment, the second brace 502 is a mirror image of the first brace 500. Therefore, the following description of the first brace 500 is applicable to the second brace 502. Accordingly, to avoid redundancy, the second brace 502 is not separately described herein.

The first brace 500 extends substantially perpendicularly from the spine 422 and toward the cap 112. The first brace 500 also extends from the claw 120 to the shank 104. The first brace 500 includes a first leg 504, a first arm 506 and a first foot 508. The first arm 506 extends from the first leg 504 at or near a junction of the first brace 500 and the claw 120. The first arm 506 of FIG. 5 is a lobe or semi-circular protrusion. The first arm 506 includes a first opening 510 that aligns with (e.g., is substantially concentric with) the first aperture 414 of the body 114. A first boss 512 surrounds or encircles the first opening 510 and extends away from the second brace 502.

As described in greater detail below, the first foot 508 extends from the first leg 504 such that the first foot 508 and the first leg 504 form a V-shape or elbow. In the illustrated embodiment, the first foot 508 includes a second opening 514 that aligns with (e.g., is substantially concentric with) the second aperture 416 of the body 114. A second boss 516 encircles the second opening 514 and extends away from the second brace 502.

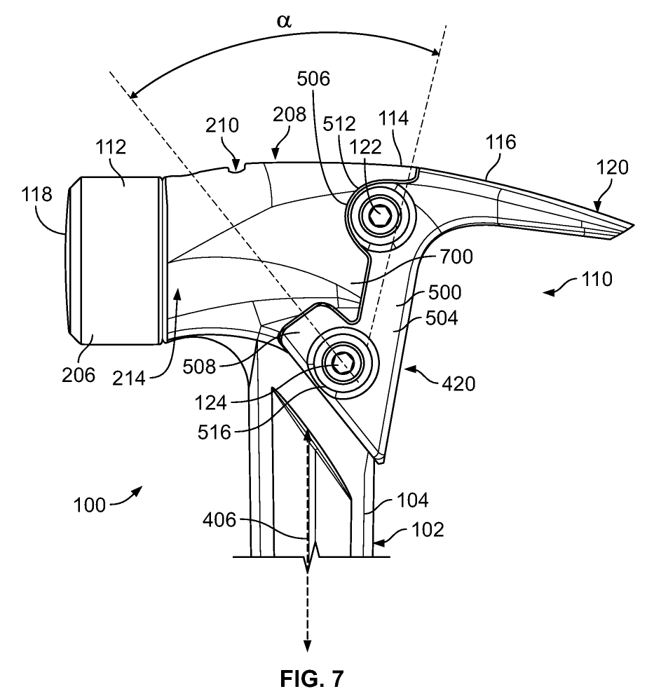

FIG. 7 is a side view of the striking tool 100 of FIGS. 1-6. From the perspective shown in FIG. 7, the central, longitudinal axis 406 of the handle 102 is vertical. In the illustrated embodiment, the first brace 500 is received in the first recess 212. Thus, the first brace 500 overlaps a portion of the first lateral side 214 of the body 114 of the head 110. The first arm 506 is disposed in the first section 218 of the first recess 212. The first leg 504 is disposed in the second section 220 of the first recess 212. The first foot 508 is disposed in the third section 222 of the first recess 212. Thus, in the illustrated embodiment, a shape of the first recess 212 substantially corresponds to a shape of the first brace 500.

The first foot 508 of the first brace 500 extends from the shank 104 toward the cap 112 and the top side 208 of the body 114. As a result, the first foot 508 and the first leg 504 form a V-shape or elbow. In the illustrated embodiment, the first foot 508 extends from the first leg 508 at an acute angle α. In some embodiments, the acute angle α is about 45 degrees. The first brace 500 mates with or cups a nodule or protrusion 700 on the first lateral side 214 of the body 114 such that the protrusion 700 is captured between the first arm 506 and the first foot 508.

The first fastener 122 and the second fastener 124 squeeze the first brace 500 toward the second brace 502 and the second brace 502 toward the first brace 500. Thus, the implement 116 is clamped to the first lateral side 214 and the second lateral side 300 of the body 114 and is in contact with the butt end 216. As a result, when the claw 120 applies force to, for example, a nail to remove the nail from an object, a load transmitted from the claw 120 to both the shank 104 and body 114 is distributed over a surface area having an extent such that the load is less than a compressive strength and a tensile strength of the shank 104 and the body 114. As a result, even though the implement 116 has a greater hardness than the shank 104 and the body 114, operation of the claw 120 does not warp or damage the shank 104 or the body 114. Also, the hardness of the implement 116 resists deformation and/or damage to the implement 116 when employed (e.g., to pry a nail). Using a Static Force Test as set forth in ASME B107.400-2008 (B107.41), the striking tool 100 having a head weight of 14 ounces can bear a static force of at least 266 pounds without permanent deformation of the implement 116, the body 114, or the handle 102. In the Static Force Test described in ASME B107.400-2008 (B107.41), the head is locked securely in test fixture with the striking face down and the handle extended in the horizontal plane, and a static force is applied vertically at a point on the handle measuring 10 in. from the top of the hammer.

Although example striking tools are disclosed herein, the scope of coverage of this patent is not limited thereto. On the contrary, this patent covers all methods, apparatus and articles of manufacture fairly falling within the scope of this patent either literally or under the doctrine of equivalents.

We claim:

1. A striking tool, comprising:
a body having a first lateral side and a second lateral side opposite the first lateral side;
a handle including a shank, the body integral with the shank;
an implement including a bracket, the bracket abutting a butt end of the body and the handle and overlapping a portion of the first lateral side of the body; and
a fastener extending from the first lateral side toward the second lateral side and through the bracket.

2. The striking tool of claim 1, further comprising:
a post extending from the body; and
a cap coupled to the post, the cap including a striking surface.

3. The striking tool of claim 1, wherein the bracket includes an arm, the fastener extending through the arm.

4. The striking tool of claim 3, wherein the fastener is a first fastener, the bracket includes a foot, and the striking tool further comprises a second fastener extending through the foot.

5. The striking tool of claim 4, wherein the foot and the arm capture a portion of the body between the foot and the arm.

6. The striking tool of claim 5, wherein the bracket includes a leg, wherein the leg and the arm form an elbow.

7. The striking tool of claim 1, wherein the body is a first material having a first hardness, the implement is a second material having a second hardness, and the first hardness is less than the second hardness.

8. The striking tool of claim 7, wherein the body is aluminum, and the implement is steel.

9. The striking tool of claim 1, wherein the head includes a cavity, the striking tool further comprising shot disposed within the cavity.

10. A hammer, comprising:
a claw including a bracket, the bracket having a first brace, a second brace, and a channel disposed between the first brace and the second brace, the first brace including an arm and a foot;
a body, a portion of the body received in the channel, a protrusion of the body captured between the arm and the foot; and
a handle, a portion of the handle received in the channel.

11. The hammer of claim 10, wherein foot extends from the handle toward a striking surface of the hammer and a top side of the body.

12. The hammer of claim 10, wherein the body and the handle are aluminum, and the claw is steel.

13. The hammer of claim 12, wherein a cap is coupled to the body, the cap including a steel striking surface.

14. The hammer of claim 10, wherein first brace overlaps a portion of a first lateral side of the body.

15. The hammer of claim 10, further comprising a fastener extending through the first brace, the body, and the second brace.

16. The hammer of claim 10, wherein the bracket includes a spine abutting a butt end of the body.

17. The hammer of claim 10, wherein the body includes a post having a bore, and a cap is coupled to the post to cover an opening of the bore.

18. The hammer of claim 17, wherein shot is disposed in the bore, the shot filling about 40 percent to about 60 percent of the bore by volume.

19. A hammer, comprising:
a body having a butt end and a recess, the recess extending from the butt end toward a striking surface of the hammer; and
a claw having a bracket, the bracket including an elbow, the elbow received in the recess such that the bracket captures a portion of the body.

20. The striking tool of claim 19, further comprising:
a handle extending from the body, wherein the recess extends from the body to the handle, and a portion of the bracket is received in the recess and overlaps a portion of a first lateral side of the handle.
